(19) United States
(12) Patent Application Publication
(10) Pub. No.: US 2007/0014121 A1
(43) Pub. Date: Jan. 18, 2007

(54) Detachable light for vehicle interiors

(76) Inventor: Andres Yepes Gomez, Medellin (CO)

Correspondence Address: Andres Yepes Gomez, Carrera 42 # 7A Sur 92 Apto 102, Medrllin, CO

(21) Appl. No.: 11/180,500

(22) Filed: Jul. 13, 2005

(51) Int. Cl. B60Q 3/00

(52) U.S. Cl. 362/486; 362/488; 362/549

(57) ABSTRACT

An Interior vehicle lamp designed to be detachable (23) from its main body (21), while at the same time providing the same features that the actual vehicle interior lamp provides. Because this is detachable, it also can be used to illuminate all the places that the user wants. The limitations are according to the cable length in the corded version (23A) and in the battery version (23B) by the battery life outside the main body. Another part of this invention is a hands free set (117) which is designed to provide a long range of lamp (23) positions: the lamp (23) can be moved along the rail (122) and at the same time rotated in the axle (120). When it is fixed, the design allows the user to remove the detachable lamp (23) and replace it again in the main body (21). Almost all the parts can be made from extruded plastic, except electrical connections, cables etc.

### CROSS-REFERENCE TO RELATED APPLICATIONS

Not Applicable

### FEDERALLY SPONSORED RESEARCH OR DEVELOPMENT

Not Applicable

### SEQUENCE LISTING OR PROGRAM

Not Applicable

### BACKGROUND OF THE INVENTION

1. Field of the Invention

This invention is an illuminating device. More specifically, the present invention is a light. This light is located in the interior of a vehicle.

2. Prior Art

The electrical interior light for vehicles was developed after the two basic inventions which became the standard in the vehicle the accumulator and the alternator. Those devices allow the vehicle to use electrical gadgets in the interiors. The accumulator provides electrical energy when the vehicle is not running and also provides the electrical energy required to start the engine (combustion engines), and the alternator provides electrical energy when the engine is running.

So almost all vehicles have a source of electrical energy. This source provides the occupants of the vehicle the use of electrical gadgets, and the interior light is one of these gadgets. The basic design of this light consist of three main systems: Light chassis, Light bulb and Three Position Switch (On, Door, Off).

Currently the lights in vehicle interiors are fixed to the roof and only able to illuminate the surrounding area. This makes it difficult to illuminate other places inside the vehicle. With the fixed light the user is not able to illuminate other specific points inside the vehicle, where it is needed, like under the chair, near the feet or even outside the vehicle. This problem has been partially solved by placing lamps in other places where light is typically needed, or giving the light side-to-side or rotational mobility, but the light is still in its original place and is not sufficiently versatile.

Another improvement is related to the switch. Originally, interior lights had an exterior independent switch, generally located next to the light but also sometimes located in the driver instrument panel.

Nowadays the switch is the light itself. You move the illuminating surface back or forward or you can also activate just pushing the light, “according to the design” to turn on or off the light. Generally this is a three position switch. The first position is called “on” and in this position, the light remains on. The second position is called “door”, and in this position the lamp turns on if at least one of the doors of the vehicle is open. The third position is called “off” and in this position the lamp remains off regardless of whether the door is open.

### OBJECTS AND ADVANTAGES

Besides the objects and advantages of the detachable light for vehicle interiors described in my above patent, several objects and advantages of the present invention are:

(a) the occupants of the vehicle are able to extract the interior light from its chassis and illuminate any places inside the vehicle using the interior light that the other standard lamp was not able to illuminate.

(b) the occupants of the vehicle are able to extract the interior light from its chassis and illuminate any places outside the vehicle using the interior light that the other fixed lamp was not able to illuminate.

(c) the light provides the same features as the regular interior light, fixed light, three positions switch (on, door, off) etc.

(d) the energy used for illuminating is provided by the vehicle, and passes to the light by a cord or its used to feed batteries inside the extractable light.

(e) the detachable light after removal can be momentarily fixed to ball-axle-rail a mechanism, whose purpose is to support the lamp and allow the user to direct the light in different directions, in different places where the mechanism is installed. It is a hands free set.

One of the improvements in this invention is that previously the occupants of the vehicle did not have the option of directing this light to certain areas in the vehicle; the light was fixed in the interior of the vehicle. With this improvement the occupants can use the interior light of the vehicle like a hand light, which gives the option of extracting the light from its chassis and directing the light to any place in the interior or exterior around the vehicle. This design also has other accessories and mechanisms that help the user to hold and direct the light's lamp.

### SUMMARY

In accordance with the present invention, an extractable light for vehicle interiors consists of two main parts: the chassis and an extractable light.

This device is general located on the roof of the vehicle interior. The extractable light has the object of providing light to any place where it is needed when you use a vehicle provided with this device. When it is powered by a cord, the user is limited in distance by the length of the cord; when is powered by rechargeable batteries, there are no distance limitations, but it is limited by the life of the battery.

### DRAWINGS—FIGURES

FIGS. 1A and 1B are perspective views of how detachable light from vehicles interiors can be extracted from his main body;

FIG. 2 is a perspective view of detachable light powered by a cord.

FIG. 3 is a perspective view of detachable light powered by a rechargeable battery.

FIG. 4 is a perspective view of detachable light chassis completely assembled with top cover.

FIG. 5A is a magnified perspective detail view of the detachable light holder mechanism behind the top cover.

FIG. 5B is a magnified perspective detail view of the detachable light holder mechanism with top cover.

FIG. 6A-6C is a perspective partial sectional view of principal operation of the holder mechanism.

FIG. 7A and 7B are top partial sectional views of principal operation switch cable locker mechanism.

FIG. 8A-8C are top partial sectional views of electric switch mechanism.

FIG. 9A is top partial sectional view showing electrical connections inside complete assembled spool.

FIG. 9B is side exploded view of different parts of complete assembled spool.

FIG. 10 is a top view of partial assembled chassis it showing all electrical connections.

FIG. 11A and 11B is a perspective view of the detachable light and showing how work push up switch.

FIG. 12A-12C are a side view of the detachable light showing how to work side to side switch.

FIG. 13A shows a cross-sectional view from the top of the detachable light.

FIG. 13B shows a cross-sectional view from the left in FIG. 13A taken thought cut BB.

FIG. 13C shows a cross sectional view from the front in FIG. 13A taken thought cut CC.

FIG. 14 is a perspective exploded view of detachable light and hands free set.

FIG. 15A and 15B shows front and left views of detachable light with rounded chassis.

FIG. 16A and 16B shows front and left views of detachable light with angled chassis.

### DRAWINGS—REFERENCE NUMERALS

| | | | |
|---|---|---|---|
| 5 | enlarged view of holder mechanism | 20 | top cover |
| 21 | main body | 22 | chassis |
| 23A | detachable light powered by cord | 23B | detachable light powered by rechargeable |
| | | | batteries |
| 23C | detachable light with push up switch | 23D | detachable light with side to side switch |
| 23E | detachable light with angled chassis | 24A | Illuminating surface designed for a |
| | | | detachable light powered by a cord. |
| 24B | Illuminating surface designed for a | 24C | Illuminating surface designed for a push up |
| | detachable light powered by batteries. | | electrical switch. |
| 24D | translucent part, designed for side to | 24E | translucent part, for detachable light designed |
| | side electrical switch. | | with angled chassis. |
| 25 | cord lock system. | 26 | cord lock switch. |
| 27 | electrical switch system. | 28 | power electric switch. |
| 30 | finger hole. | 32 | electrical power cord. |
| 34 | electrical cord protector. | 36A | detachable light chassis designed for a |
| | | | detachable lamp powered by a cord. |
| 36B | detachable light chassis designed for a | 36C | detachable light chassis designed for a |
| | detachable light powered by batteries | | push up electrical switch. |
| 36D | detachable light chassis designed for a | 36E | angled detachable light chassis. |
| | side to side electrical switch. | | |
| 37 | holder mechanism. | 38 | holder pin hole. |
| 40A | cable hole in main body | 40B | Cable hole in detachable light. |
| 42 | holder pin. | 44 | torsion spring. |
| 46 | mounting screw. | 48 | rolling part. |
| 50 | detachable light hole in top cover. | 52 | angled hole in detachable light chassis. |
| 54 | reflector. | 55 | spool assemble. |
| 56 | spool. | 58 | axle for spool. |
| 60U | upper chassis fixer screw. | 60D | chassis fixer screw. |
| 60L | left chassis fixer screw. | 60R | right chassis fixer screw. |
| 62 | spool rib. | 64 | lock flange. |
| 66 | rib flange. | 68 | spool hole. |
| 70 | switch rib. | 72 | pin electrical connector. |
| 74 | door electrical connector. | 76 | door cable. |
| 78A | chassis electrical switch support off. | 78B | chassis electrical switch support door. |
| 78C | chassis electrical spool switch support | 78D | chassis electrical switch support on. |
| | connection. | | |
| 80 | spool pin electrical connector. | 82 | on electrical connector. |
| 84 | helix spring spool fixer. | 86 | helix spring axle fixer. |
| 88 | spool axle hole. | 90 | positive cable on cord. |
| 92 | negative cable on cord. | 94 | spool pin electrical connector. |
| 96 | spool hole for helix spring spool fixer. | 98 | spring for spool pin. |
| 100 | helix spring. | 102 | spool top. |
| 104 | spool top flanges. | 106 | spool holes for top flanges. |
| 108 | cable positive feed connection. | 110 | space for cord lock switch |
| 112 | space for electrical switch. | 114 | light bulbs. |
| 116 | light bulb connector. | 117 | hands free set. |
| 118 | rotating ball. | 119 | rotating ball support. |
| 120 | hands free set axle. | 122 | hands free set rail. |
| 124 | detachable chassis axle hole for | 126 | rotating boll axle hole. |
| | hands free set. | | |
| 128 | retractable axle top system. | 130 | axle base. |

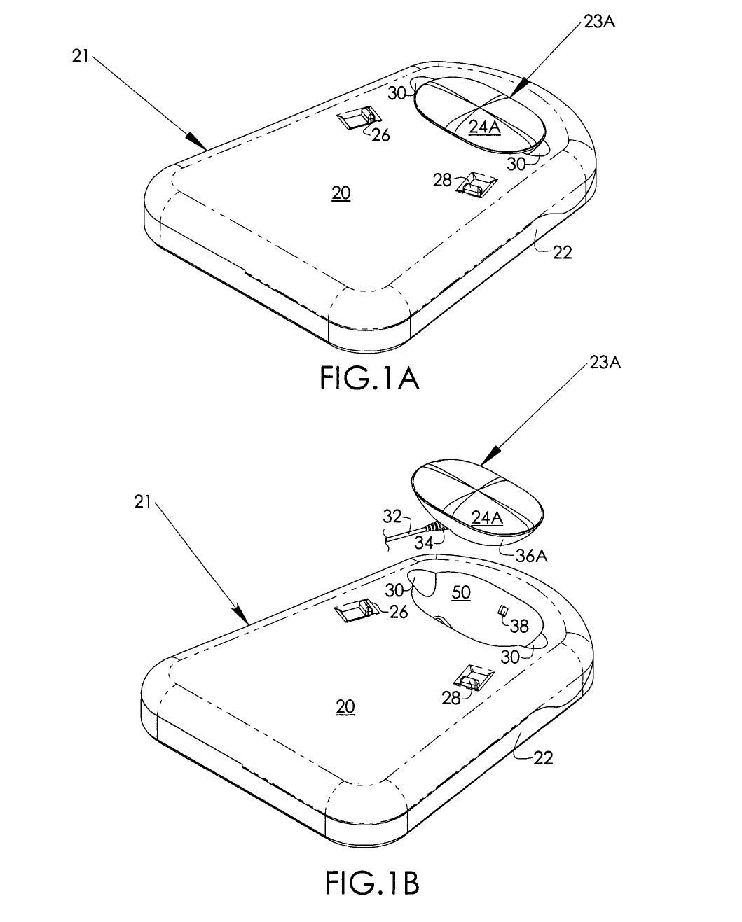

### DETAILED DESCRIPTION—FIGS. 1A AND 1B—PREFERRED EMBODIMENT

Referring now to FIG. 1A and FIG. 1B, a detachable light for vehicle interiors, shown in perspective view, is composed of two parts designated by numeral 21 for main body and 23 for detachable lamp. While the invention will be described generally with reference to a device shown in FIG. 1A and FIG. 1B, it is to be understood that there are many similar devices and various embodiments and improvements which are subjects of the present invention. The configuration of a detachable light for vehicle interiors shown in FIG. 1A and FIG. 1B is referring to a corded configuration, is characterized by the fact that main body 21 has a hole 50 in top cover 20 that has the same shape as detachable lamp chassis 36, main body 21, which is permanently connected to a detachable lamp 23 by a retractable electrical cord 32.

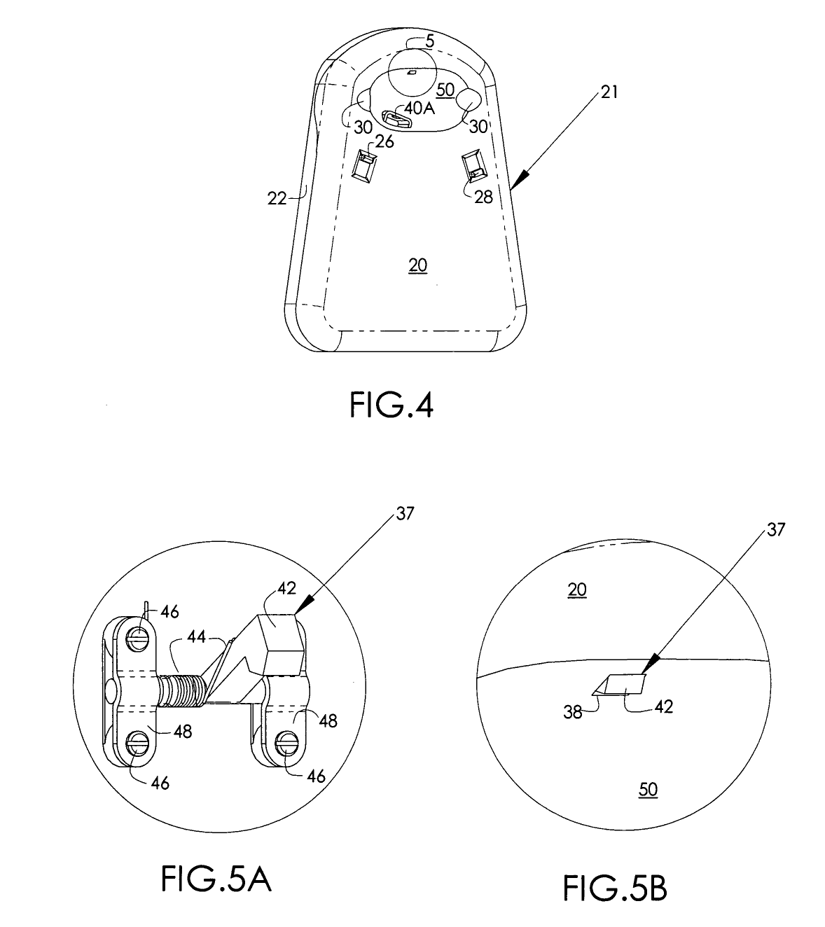

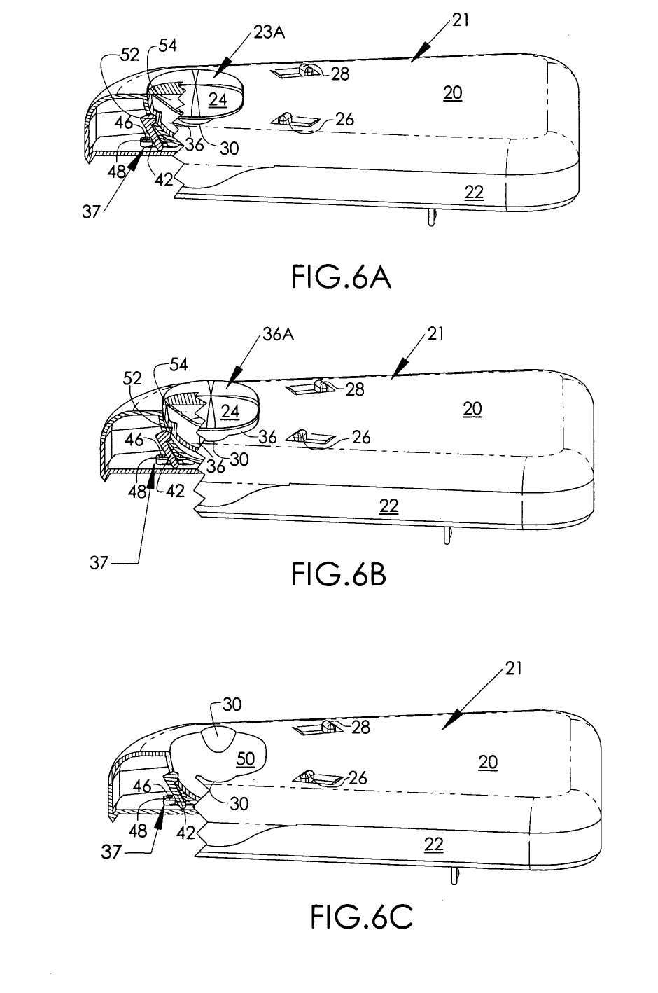

In addition the main body 21 shown in FIG. 1A, FIG. 1B and FIG. 4 has a system inside called holder mechanism 37 as shown in FIG. 5A. It is composed of holder pin 42 which is pivoted in rolling part 48 and also a torsion spring 44 is coupled with the system as shown in FIG. 5A. The top cover 20 has a hole called holder pin hole 38 which is located in accordance with the position of the holder mechanism and only a small angled part of holder pin 42 passes through the hole as shown in FIG. 5B. The holder pin hole is located in the surface of a detachable light hole in top cover 50, and also has to match with the angled hole in detachable light chassis 52 as shown in FIG. 6A.

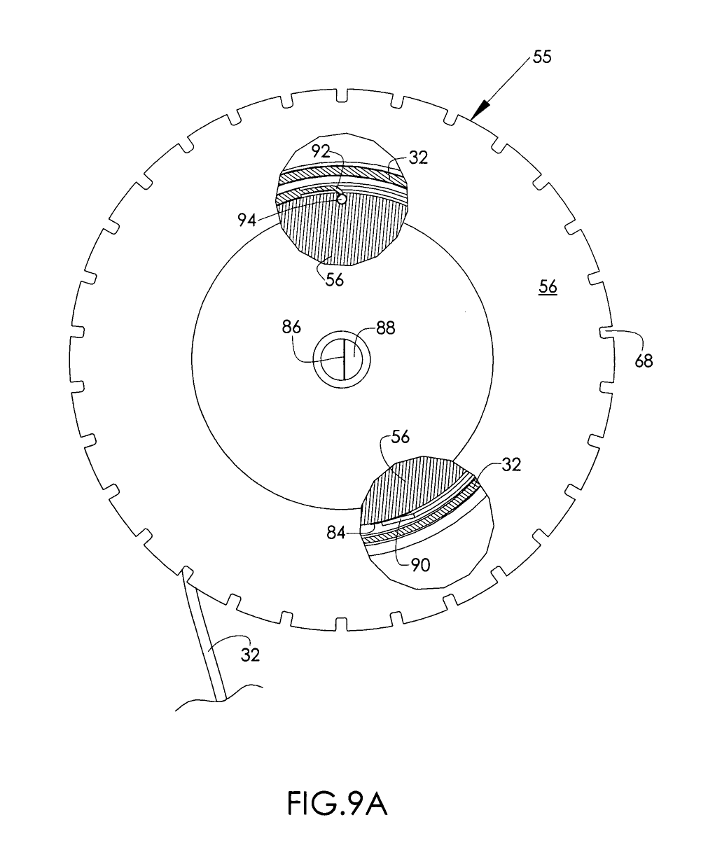

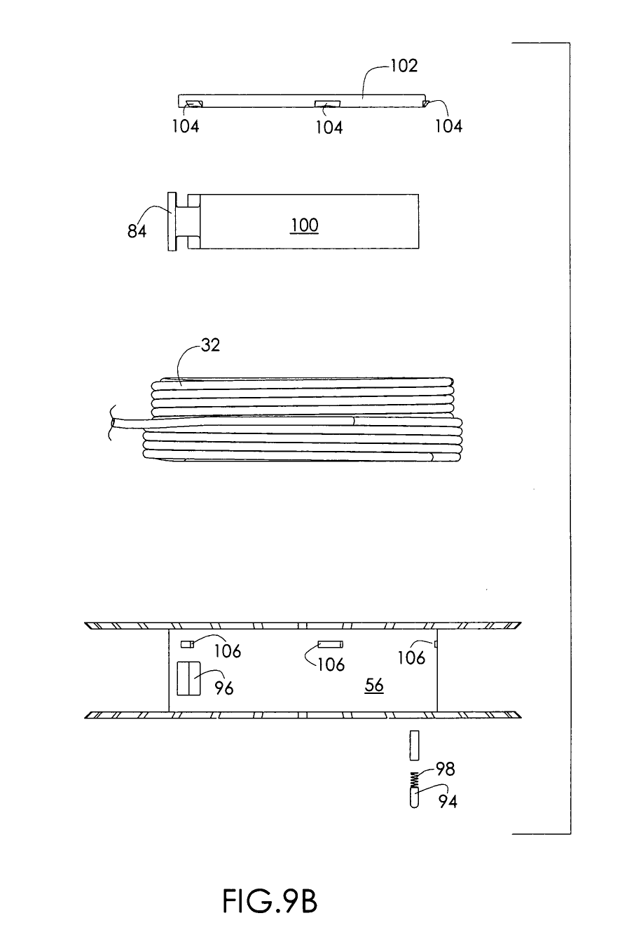

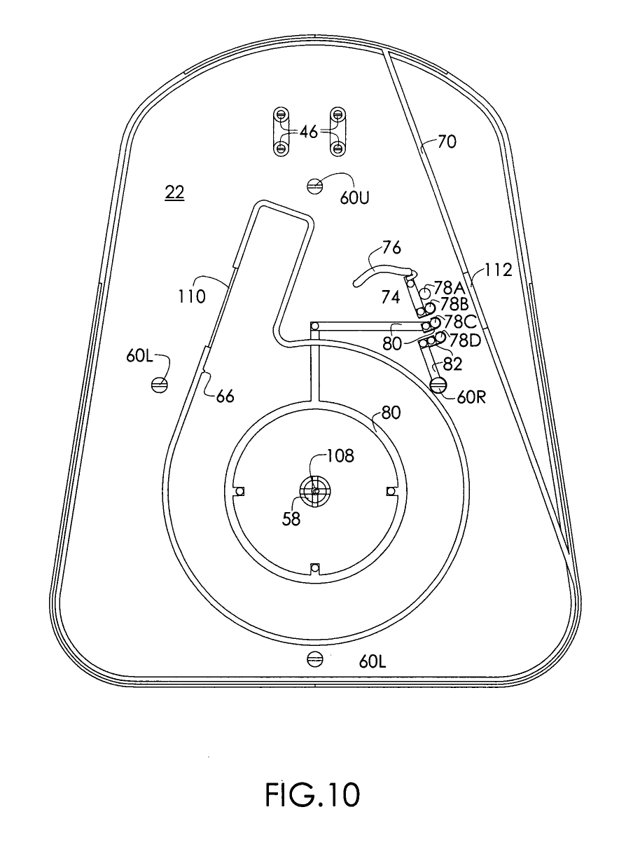

The electrical cord 32 has a retractable mechanism 55 as shown in FIG. 9A which is located inside the main body 21 and is called spool assemble 55 This mechanism is composed of a spool or reel 56, and is physically attached through spool hole 96 to helix spring 100 by helix spring spool fixer 84 as shown in FIG. 9B. The spool top 102 keeps helix spring 100 inside the spool 56. Spool top 102 and spool 56 have an axle hole 88 called spool axle hole 88 shown in FIG. 9A, which matches in diameter and length with chassis axle 58 shown in FIG. 10. Also the helix spring is attached to the chassis axle 58 by helix spring axle fixer 86, at the end of the helix spring. The positive cable feed connection 108 passes through the chassis 22 and is connected to helix spring 100 at helix spring axle fixer 86 as shown in FIG. 9A and FIG. 10. The helix spring 100 is connected to a positive cable on cord 90 at helix spring spool fixer 84. The negative current come to spool 56 from spool electrical connector 80 through spool pin electrical connector 94 as shown in FIG. 9A, FIG. 9B and FIG. 10. Both pieces are in permanent dynamic contact which is possible by a spring for spool pin 98. The spool pin electrical connector 94 is electrically connected to a negative cable on cord 92, so cord 32 has inside a positive cable on cord 90 and negative cable on cord 92.

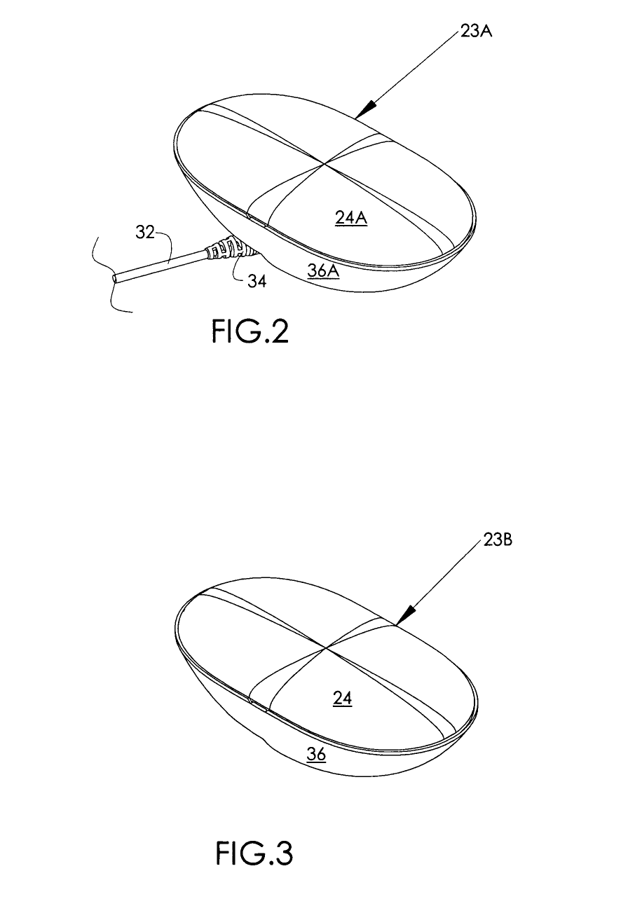

Detachable light 23 shown in FIG. 2 is connected to chassis 22 shown in FIG. 1A and FIG. 1B by cord 32 which passes through cable hole 40B, is located in a side of detachable light chassis 36A and also is attached to electrical cord protector 34 in the same place cable hole 40B. When cord 32 passes through hole 40B, it is divided in to a positive cable on cord 90, which is electrically connected to light bulb connector 116A, and negative cable on cord 92 which is electrical connected to light bulb connector 116B. Both electrical bulb connectors 116A and 116B are electrically connected to each side of the bulb. Also the electrical bulb connectors 116A and 116B pass through reflector 54 and hold light bulb 114 up. The reflector 54 is supported by detachable light chassis 36A and translucent part 24A.

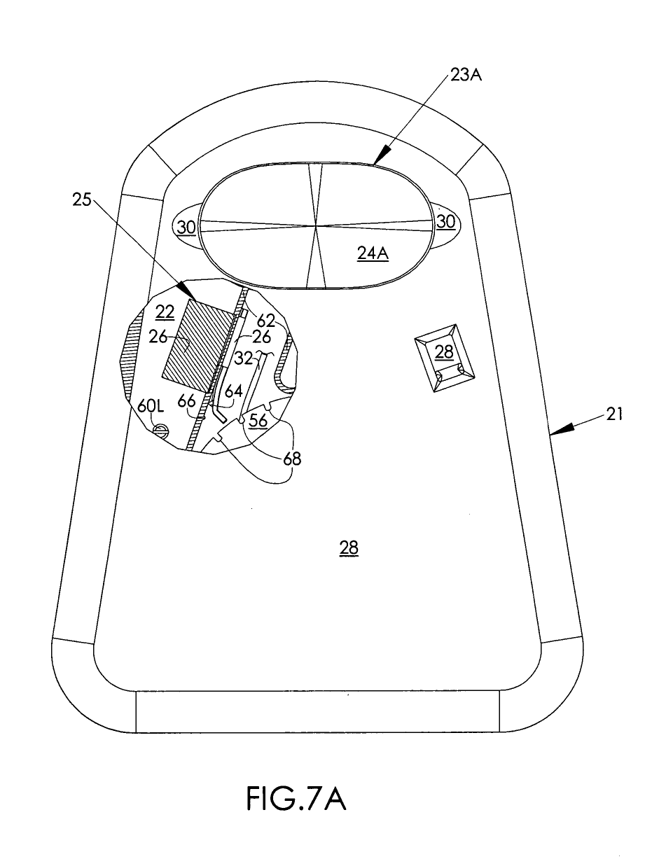

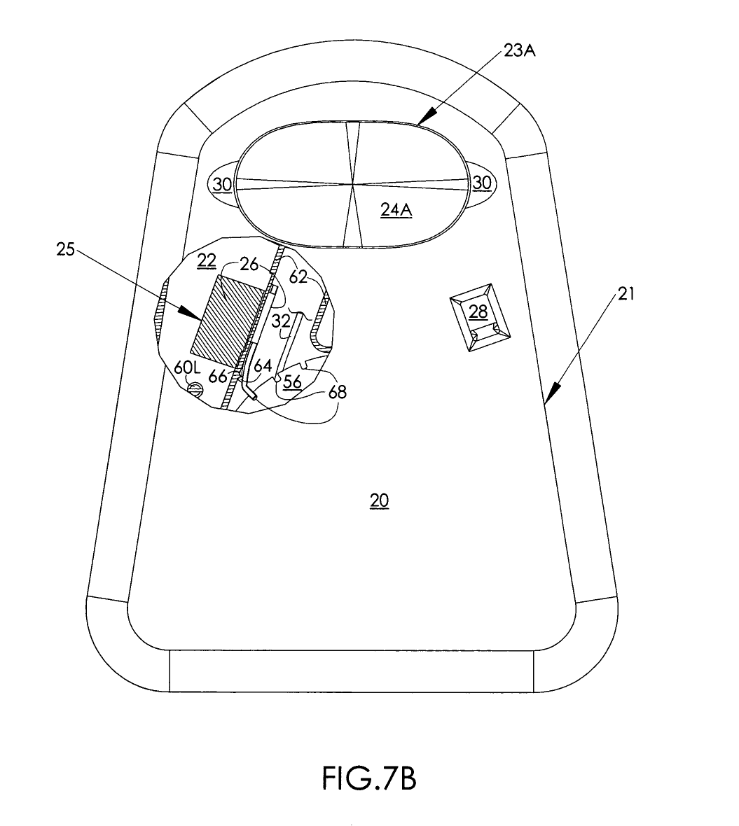

Cord lock system 25 is located inside the main body 21 as shown in FIG. 7A and FIG. 7B. The cord lock switch 26 is specifically placed in a space for cord lock switch 110 which is a hole in spool rib 62. Also the system works with lock flange 64 and rib flange 66. A part of the system in spool 56 is the serial spool holes 68.

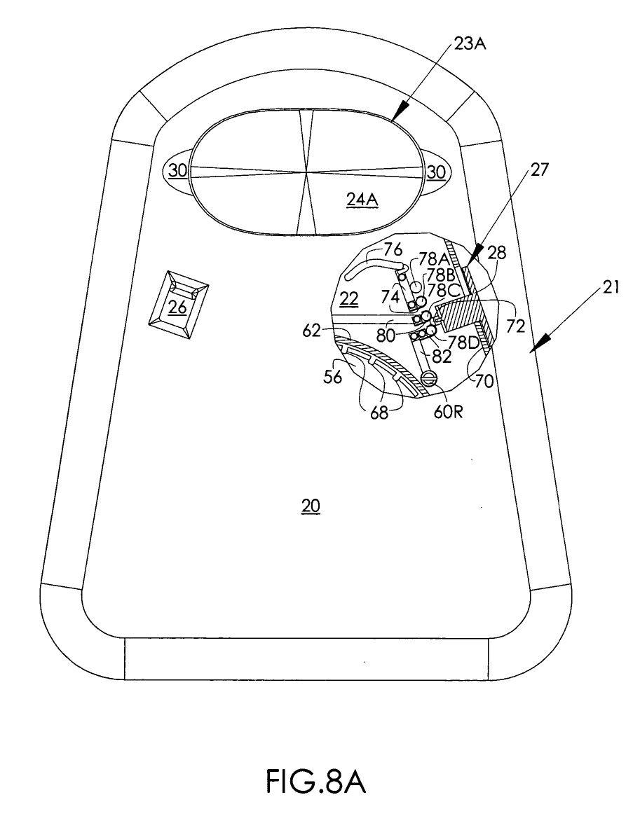

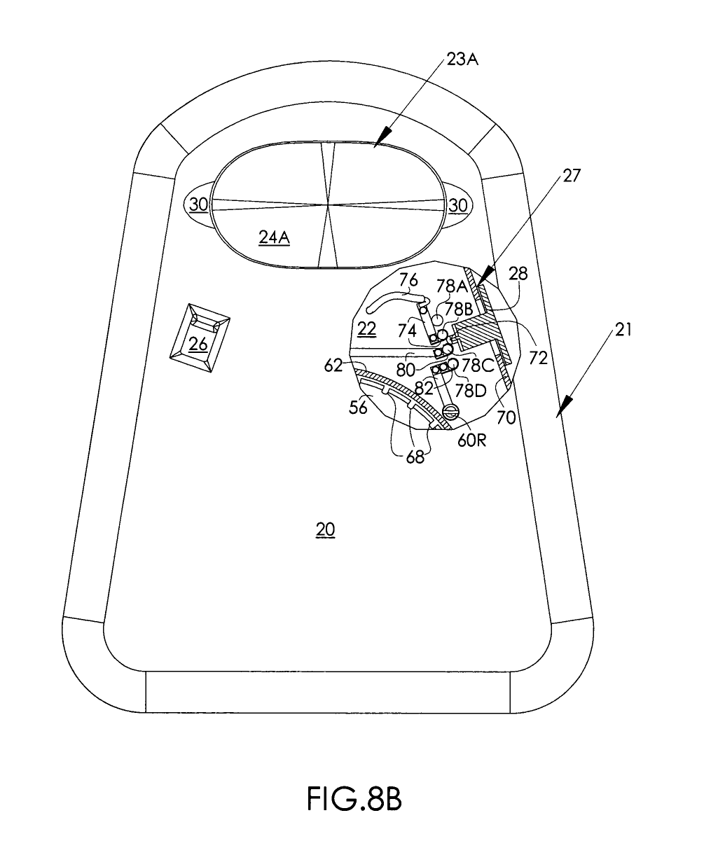

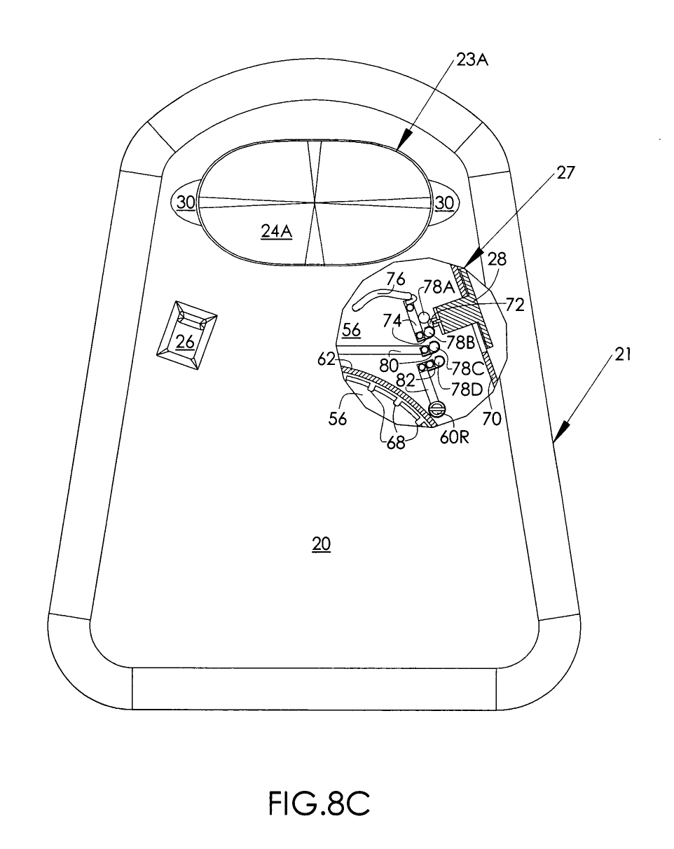

The electrical switch system 27 is located inside the main body 21 as shown in FIG. 8A, FIG. 8B and FIG. 8C. Electrical switch 28 is specifically placed in a space for electrical switch 112, which is a hole in switch rib 70, and is also part of the electrical switch 28, an spring load pin electrical connector 72 against the connections: door electrical connector 74 which is supported by chassis electrical switch support 78B and also connected to door cable 76, spool pin electrical connector 80, supported by chassis electrical switch support 78C, on electrical connector 82, which is supported by chassis electrical switch support 78C and also connected to chassis fixer screw 60R, which is permanently connected with the negative current vehicle system, and chassis electrical switch support 78A which is totally isolated from electrical connections.

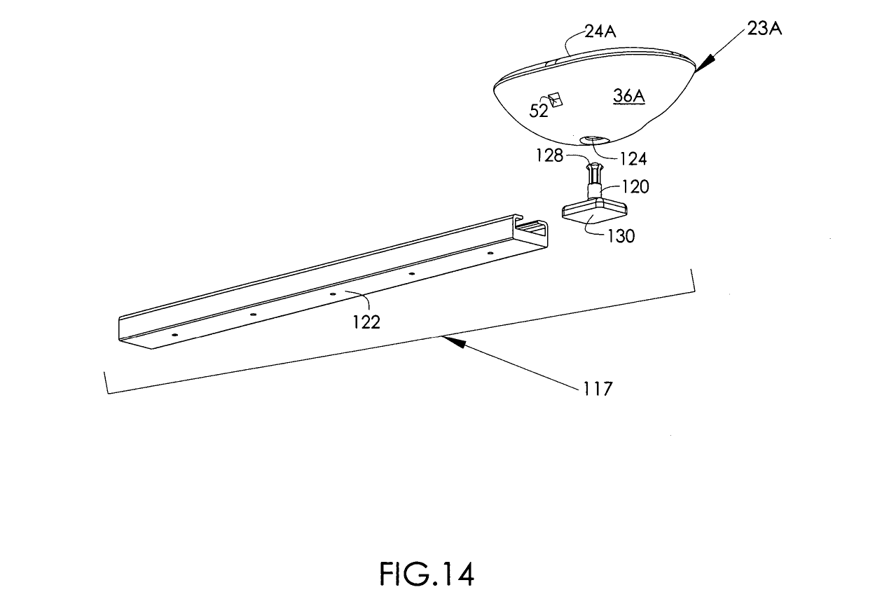

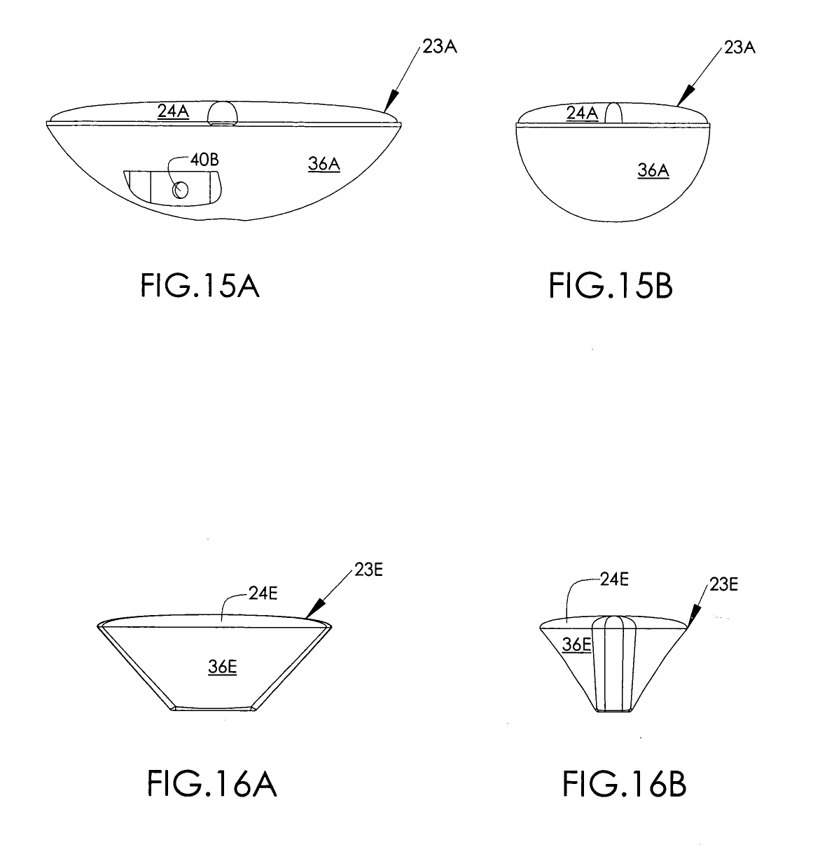

Hands free set 117 shown in FIG. 14 is a system composed by rotating ball 118 which is placed in rotating ball support 119 and has a pass through hole called rotating ball axle hole 126. The hands free set axle 120 has top retractable system 128, and its base 130 is designed to fit in the hands free set rail 122.

Operation—FIGS. 4, 5, 6, 7, 8, 9, 10

The manner of using the detachable light for vehicle interiors is identical to that for interior lights in present use. Namely, when the electrical switch system 27 is off, the light is permanently off as shown in FIG. 8C; when the electrical switch system 27 changes to a door position as shown in FIG. 8B, the light is on only if one of the vehicle doors is open or not perfectly closed; when the electrical switch system 27 changes to the on position as shown in FIG. 8A the light is on no matter whether the doors are open or closed.

The detachable light 23A can be extracted from the main body 21A as shown in FIGS. 1A and 1B just by placing the fingers in finger hole 30 and pulling out the detachable lamp 23A; the cord system 55 shown in FIGS. 9A and 9B starts to work and the cord 32 starts to come out. The cord 32 always has a force in it which pulls the cord 32 back inside the main body 21. This force can be canceled by switching the cord lock switch 26 to lock position as shown in FIG. 7B. The electrical system works in the same way regardless of whether the light is placed on the main body or is extracted.

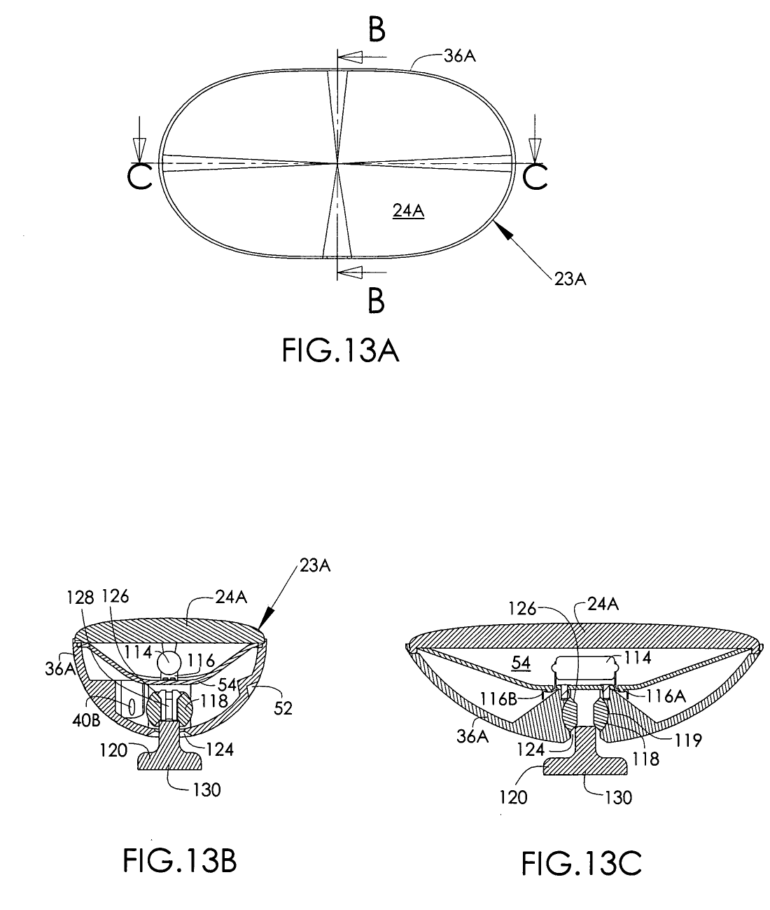

The detailed operation of the electrical system: The positive current comes to the main body 21 through the positive cable feed connection 108 as shown in FIG. 10, passes the positive current to helix spring 100 in the helix spring axle fixer 86 shown in FIG. 9A. The positive current passes through long helix spring 100 to helix spring spool fixer 84 shown in FIG. 9B. At that place it is connected to the positive cable on cord 90 as shown in FIG. 9A. The positive current passes trough electrical cable 32 and comes in to the detachable light 23A. Inside the detachable light 23A the positive cable on cord 90 is connected to light bulb connectors 116A and this passes the positive current to the light bulb's positive side as shown in FIG. 13C.

The negative current is connected to the three position switch so there are different ways to the negative current to come in to the detachable light 23A. The door position as shown in FIG. 8B is when the negative current coming from the doors cable switches (not shown) to the door cable 76, which is connected to door electrical connector 74. When the switch is in door position, the negative current passes through pin electrical connector 72 and comes into spool pin electrical connector 80 which makes a dynamic electrical connection at the circled section of the piece: spool pin electrical connector 80 shown in FIGS. 9B and 10. This is connected to the negative cable on cord 92 as shown in FIG. 9A which takes the negative current along the cord 32 and bring into the detachable light 23A. Inside the detachable lamp 23A the negative cable on cord 92 is connected to light bulb connector 116B. This passes the positive current to the light bulb's positive side as shown in FIG. 13C.

The on position as shown in FIG. 8A is when the negative current comes in to the main body 21 through the chassis fixer screw 60R and is electrically connected to on electrical connector 82, then the current passes trough pin electrical connector 72 to spool pin electrical connector 80 which makes a dynamic electrical connection at the circled section of the piece: spool pin electrical connector 80 shown in FIGS. 9A and 10. This is electrically connected to a negative cable on cord 92 as shown in FIG. 9A which takes the negative current along the cord 32 and brings it into the detachable light 23A. The negative cable on cord 92 is connected to light bulb connector 116B inside the detachable light 23A and this passes the positive current to the light bulb's positive side as shown in FIG. 13C.

The off position is when electrical connector 72 connects the insulated chassis electrical switch support 78 with door electrical connector 74 so no negative current flows through spool pin electrical connector 80 and there is no way for any negative current to come to detachable light system 23A as shown in FIG. 8C.

The cord 32 is totally rolled up on the spool when the detachable light is placed in the detachable lamp hole 50 on top of cover 20 as shown in FIGS.1A and 6A and is held in that hole by the holder mechanism 37 in which there is holder pin 42 which is pivoted in rolling part 48, and the torsion spring 44 provides force to keep the holder pin 42 placed in holder pin hole 38 as shown in FIG. 5A. This design is made only to the holder pin angled head 42 passing through holder pin hole 38 and this angled head is placed in the angled hole in detachable light chassis 52 as shown in FIG. 5B, and in this way the force of the spring is used to keep the detachable light 23A in the hole in top cover 50.

When someone puts a finger in finger hole 30 and stars to pull out the detachable light the holder mechanism 27 starts to release the detachable light 23A as shown in FIG. 6B because it starts to apply force from the angled hole in detachable light chassis 52 to the holder pin at angled head 42 and cancel the force coming from the spring. The holder pin 42 then moves back to allow removal of detachable light 23A as shown in FIG. 6C.

The detachable light 23A is pulled and rolls out of the spool 56, which starts to release electrical cord 32. The spool is placed in the chassis axle of spool 58 shown in FIG. 10 at the spool axle hole 88 and has a helix spring 100 in its interior shown in FIG. 9B. The helix spring 100 at helix spring axle fixer 86 shown in FIG. 9A is attached from chassis axle of spool 58 shown in FIG. 10 to the spool hole for helix spring spool fixer 96 at helix spring spool fixer 84. The spring is loaded and provides force to the spool to keep the electrical cord 32 rolled on it.

The task of cord lock system 25 is to cancel the force provided from the helix spring 100 to spool 56. The cord lock system 25 has two positions. When it is free, shown in FIG. 7A, the cord lock switch 26 has no physical contact with the spool but is designed to move along the space of cord lock switch 110. In this position the rib flange 66 does not allow the cord lock switch 26 to pass to lock position by accident because it is in the way of lock flange 64; if someone tries to pass the cord lock system 25 to lock position, the lock flange 64 passes over the rib flange 66 and the cord lock switch is temporally deformed within the plastic deformation range and then after passing over it, immediately recover its original shape. The end of the cord lock switch is placed in one of the spool holes 68 located around spool 56 as shown in FIG. 7B.

Another accessory for this invention is the hands free set 117 which is composed of rail 122, the hands free set axle, and rotating ball 118 as shown in FIG. 14. Various rails and their respective glide axle can be placed and fixed in the interior or exterior of the vehicle, wherever the vehicle designer considers necessary.

The axle base 130 is designed to slide along rail 122. The top of the axle 120 has a double side chamfers and axle cut as is shown in FIG. 14. Rotating ball 118 has the same angled chamfer in both sides of the hole 126. It is located inside detachable lamp 23. If the user puts axle 120 in hole 124 and applies force to the top of axle retractable system 128 the ball chamfered hole 126 makes the axle reduce its diameter and occupy the free space in the x cut so the axle can pass along the whole angled hole. Axle 120 undergoes temporary plastic deformation so when it is pushed at the end, the axle fills the space in the opposite side of the chamfered hole 126 as shown in FIG. 13B. This feature allows the detachable light to be used plugged or unplugged and directs the lamp to the place where it is needed.

FIGS. 3, 11, 12, 16—Alternative Embodiments

An additional design is the detachable light system powered by batteries 23B so the system turns into a detachable cordless light 23B as shown in FIG. 3. The main body 21B contains the same holder mechanism 37 in its interior but in this design two or more holder mechanisms 37 are required, which are placed in opposite sides of the detachable light 23B. Another difference is related to the electrical switch, which has to be placed in detachable light 23B not in main body 21B.

The rechargeable battery system (not shown) is also located in the interior of the main body 21B and receives the vehicle current and fits it to the requirements of the batteries installed in the detachable light 23B. The main body 23B and the detachable light 23B are electrically connected by an electrical independent positive and negative non-permanent connection, which is connected only when the detachable light is placed in the main body 21B. This non permanent connection is preferably located in the place where the cable hole 40B in the detachable light 23A and 40A in the main body 21A in the corded version are located because this feature makes it impossible to place the detachable light 23B in main body 21B in the wrong positions because the only way to place it is the way the non permanent electrical connection is connected. The entire electrical system located in the main body 23B and the way the batteries work is prior art and consequently is not explained in detail.

Main body 21A is similar, except that the electrical switch system 27 is located on the vehicle instrument front panel. In this design the switch connections are similar and the main body positive current comes though the same cable feed connection 108, but the switch system is outside so the negative current comes from the switch system by negative cable which is electrically connected to spool pin connector 80. The fixer screw 60 R in this case is totally isolated from negative current and has no electrical connections.

Main body 21A is similar, except that the electrical switch is located in the detachable light and is activated by pushing translucent part 24C against the detachable light 36C as shown in FIG. 11A and FIG. 11B.

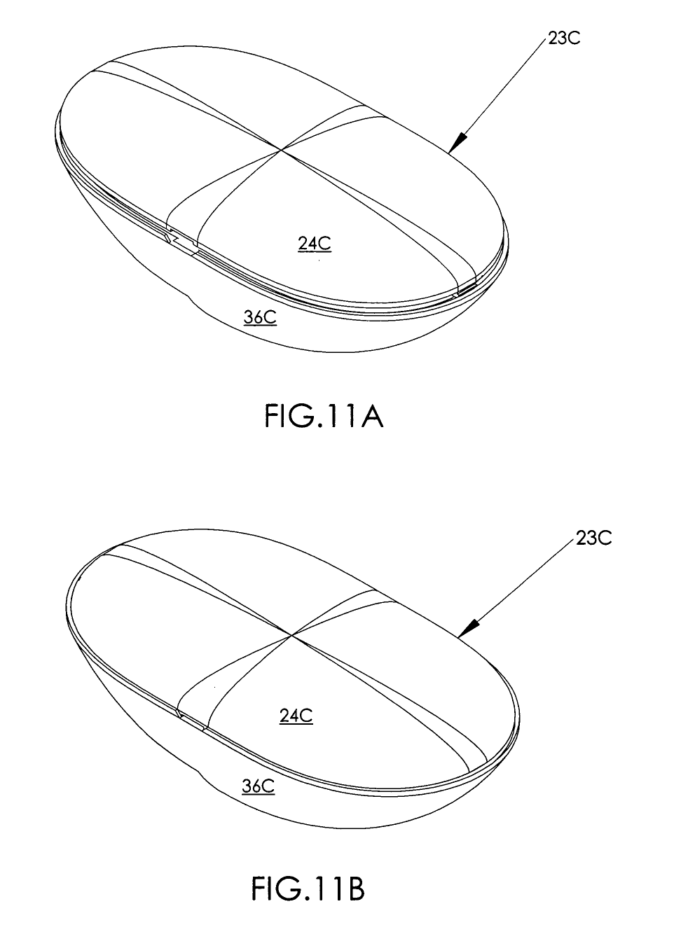

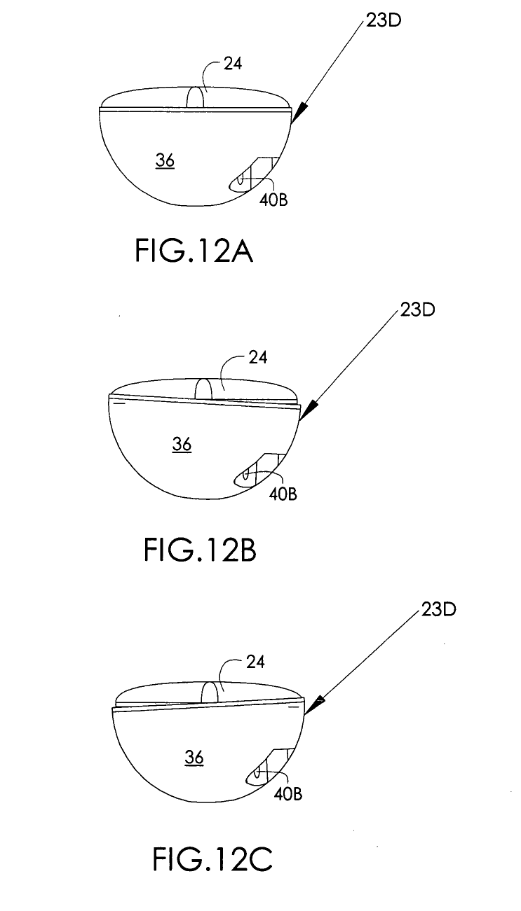

A similar main body 21A but with the electrical switch located in the detachable light and activated by moving the translucent part 24D side to side in reference to detachable light chassis 36D is shown in FIGS. 12A, 12B, 12C.

In the last two systems in which the electrical switch system is located in the corded detachable light, there are 3 cables on cord 32: one for positive current, one for negative current from the doors and one for negative current for permanent on position. The third cable should have an independent similar dynamic connection as is described before, between the spool 56 and the rounded part of spool pin electrical connector 80 which is located and attached to the chassis 22.

For the batteries version, a push up or side to side electrical switch can be implemented. It has to have a third connection at the non permanent connection as mentioned before between the detachable light 23B and main body 21B which is the negative connection from the doors. In this version the door system only works when the lamp is placed in the main body. The other two positions work in the same way no matter whether the light is placed or not, so at the non permanent connection there are three connections the negative connection from permanent on, the negative connection from the door and the positive connection.

The detachable light chassis 36A and 36E shapes are specially conceived to increase the detachable light performance in two aspects. The first aspect is related to the shape, in which it becomes easy to place the lamp 23 in the main chassis 21, because when someone tries to place the light 23 in the main body 21, a perfect correspondence between the hole 50 and the lamp chassis 36 is not necessary. This is because the shapes of the lamp 36 and hole 50 force the correspondence. It is only necessary to push the detachable lamp against the main body 21. The second characteristic is related to the increased performance when the detachable light is installed in the hands free set. The shape 36 is designed to not interfere with the rotational movement. Rather, the movement is generated by the rotating ball 118.

Conclusion, Ramifications, and Scope

The reader will see that the detachable light for vehicle interiors is a versatile version of the regular vehicle interior light. It provides features that the old fixed light does not have. It can be used to illuminate any area the user wants. It is easy to detach and to ease back to place again because of its design. The light also can be used with the hands free set previously installed in certain places in the vehicle.

Although the description above contains many specifications, these should not be construed as limiting the scope of the invention but as merely providing illustrations of some of the presently preferred embodiments of this invention.

For example, there are multiple variations in the design of the detachable light for vehicle interiors. These variations are related to the designer preferences. Some are related to how the power comes into the detachable light, while others refer to internal functions like the cable look system and electrical switch systems. Others are related to the main body and detachable light shape. Finally, there are variations about whether the system is placed, if is built-in or is placed on the surface where it is installed.

Thus the scope of this invention should be determined by the appended claims and their legal equivalent, rather than by the examples given.

1. A light designed for vehicle interiors which can be detached from the main body where the detachable light is powered by a cord.

2. A electrical switch whose function is to activate or set the functions of the detachable light described in claim 1.

3. The electrical switch described in claim 2 located in the vehicle instrument panel.

4. The electrical switch described in claim 2 located in the lamp's main body.

5. The electrical switch described in claim 2 located in the detachable light.

6. The electrical switch described in claim 2 also located in the detachable light, which is activated by pushing down the illuminating surface against the detachable light chassis.

7. The electrical switch described in 2 also located in the detachable light, which is activated moving the illuminating surface side to side in relation to the detachable light chassis.

8. A system for the machine described in claim 1, located inside the main body, designed to keep the light attached to the main body and also to allow the user to detach the light when someone requires it, the system is composed by an angled head holder pin, which rotates on a rolling part and also a torsion spring which provides force to the system.

9. A switch for the machine described in claim 1 whose function is to lock the cord when the user requires it.

10. A hands free set designed to install the detachable light described in claim 15 in different places, other than the main body which is composed of a rail, axle, rotating ball, and where the axle moves along the rail and the rotating ball allows the light to rotate on that axle and change the direction of the light beam.

11. The detachable light described in claim 1 whose chassis has a rounded form.

12. The detachable light described in claim 1 whose chassis has a angled form.

13. A light designed for vehicle interiors which can be detached from the main body and the detachable light is powered by batteries.

14. An electrical switch whose function is to activate or set the functions of the detachable light described in claim 15.

15. The electrical switch described in claim 16 located in the vehicle instrument panel.

16. The electrical switch described in claim 16 located in the lamp's main body.

17. The electrical switch described in claim 16 located in the detachable light.

18. The electrical switch described in claim 16 also located in the detachable light, which is activated by pushing down the illuminating surface against the detachable light chassis.

19. The electrical switch described in 16 also located in the detachable light, which is activated by moving the illuminating surface side to side in relation with the detachable light chassis.

20. A system for the machine described in claim 15, located inside the main body, designed to keep the light attached to the main body and also to allow the user to detach the light when someone requires it, the system is composed for an angled head holder pin, which rotates on a rolling part and also a torsion spring which provides force to the system.

21. A hands free set designed to install the detachable light described in claim 15 in different places, other than the main body which is composed of a rail, axle, rotating ball, where the axle moves along the rail and the rotating ball allows the light to rotate on that axle and change the direction of the light beam.

22. The detachable light described in claim 15 whose chassis has a rounded form.

23. The detachable light described in claim 15 whose chassis has a angled form.
